(19) United States
(12) Patent Application Publication
(10) Pub. No.: US 2024/0142571 A1
(43) Pub. Date: May 2, 2024

(54) METHOD OF RADAR JAMMING BASED ON FREQUENCY DIVERSE ARRAY JAMMER

(71) Applicant: Yangtze Delta Region Institute of University of Electronic Science and Technology of China, Huzhou, Huzhou (CN)

(72) Inventors: Wenqin WANG, Huzhou (CN); Cheng WANG, Huzhou (CN)

(21) Appl. No.: 17/991,913

(22) Filed: Nov. 22, 2022

(30) Foreign Application Priority Data
Oct. 26, 2022 (CN) 2022113214408

(51) Int. Cl. G01S 7/38; G01S 7/02

(52) U.S. Cl. CPC G01S 7/38; G01S 7/021

(57) ABSTRACT

A method of radar jamming based on a frequency diverse array jammer is provided. In the method, jamming signals are transmitted through a frequency diverse array, so that the jamming signals transmitted by each array element are different in frequency. On one hand, the power of the jamming signals is enhanced by adopting an array form, which causes serious trouble to the target detection of enemy radar in the frequency domain. The frequency diverse array jammer uses a digital radio frequency memory as a front end basic component, stores and processes the received enemy detection signal, flexibly uses repeater jamming or smart jamming, and finally transmits the jamming signal in a frequency diverse array antenna mode to generate more false targets than conventional jamming, thereby effectively destroying the detection and tracking of the enemy radar on our side moving targets.

### CROSS REFERENCE TO RELATED APPLICATION

This patent application claims the benefit and priority of Chinese Patent Application No. 202211321440.8 filed on Oct. 26, 2022, the disclosure of which is incorporated by reference herein in its entirety as part of the present application.

### TECHNICAL FIELD

The disclosure relates to the technical field of radar jamming in electronic countermeasures, and more specifically, to a radar jamming technical method based on a frequency diverse array jammer. The frequency diverse array (FDA) technology is applied to the radar jammer to realize the effective jamming to the enemy radar. The method has the characteristics of strong jamming capability, high jamming efficiency, strong jamming concealment and the like, and has great research and application value for various new system radars.

### BACKGROUND ART

Radar jamming is an important part of electronic warfare, and it is also an essential part of modern electronic warfare. With the increasingly complex electromagnetic environment in the battlefield space, all countries in the world are seeking for the optimal solution to effectively control the electromagnetic space. With the development of radar theory, advanced electronic technology has been widely used in radar systems, such as pulse Doppler radar, pulse compression radar, phased array radar and synthetic aperture radar. These new system radars use various anti-jamming technologies, which significantly reduce the effect of the traditional blanket jamming and deception jamming, and greatly improve the anti-jamming capability of the radar system, which poses a severe challenge to the research of radar jamming technology. In radar jamming, in addition to ensuring that the jamming signal has enough jamming power to aim at the enemy radar in frequency, direction and polarization, a good jamming pattern is also needed to effectively jam the radar. Therefore, the effective jamming of the new system radar has become a hot research topic in the field of jamming, and the coherent jamming technology based on Digital Radio Frequency Memory (DRFM) has been widely used. DRFM can intercept, store, process and copy enemy radar signals. Currently, smart noise jamming and realistic multi-false-target deception jamming based on DRFM provide new effective jamming modes for radar. The coherent jamming technology can make the jamming signal entering the radar receiver obtain the same coherent processing gain as the true target echo. The biggest difference between it and noise jamming or other deception jamming is that it can accurately imitate the waveform of the radar transmitting signal.

The traditional blanket jamming is to use the jamming transmitter to transmit high-power jamming signals, so that the enemy's radar receiver is overloaded and saturated or the useful signal is covered by jamming, but the jamming effect of this jamming method is not very ideal for the new system radar, it cannot obtain the gain of matching reception, resulting in most of the jamming energy is not used. Its characteristics of exposure jamming are easily detected by enemy radar.

### SUMMARY

The disclosure provides a radar jamming method based on a frequency diverse array jammer. The frequency diverse array jammer takes a digital radio frequency memory as a basic component of a front end, stores and processes a received enemy detection signal, flexibly uses repeater jamming or smart jamming, and finally transmits a jamming signal in a frequency diverse array antenna mode to generate more false targets than conventional jamming, which can effectively destroy the detection and tracking of enemy radar to our moving targets.

The disclosure relates to a radar jamming method based on a frequency diverse array jammer, which includes the following steps.

Step 1: an enemy pulse Doppler reconnaissance radar located at a position E is simulated. The radar covers a certain detection area, and is marked as a T area to which the radar transmits a radar signal s(t). Through the detection of the echo signal, a foreign target entering into the area is determined.

Step 2: When our moving target enters the T area, the signal s(t) sent by the enemy radar to the area T is reflected. A part of the reflected signal is returned to the radar receiver as a true echo signal, and the other part of the signal will be reflected to the frequency diverse array jammer placed outside our area.

Step 3: The jammer repeatedly identifies and searches the signal emitted or reflected by the area. When the signal strength received by the jammer is greater than a certain threshold, it can be determined that the jammer has searched the enemy reconnaissance signal reflected by the target, otherwise it will continue to search.

Step 4: The jammer uses the DRFM to identify and store the received enemy reconnaissance signal, so as to capture and save the signal at a high speed.

Step 5: The pulse pattern, pulse period and other parameters of the radar signal received in Step 4 are accurately judged, accurately copied, and forwarded to the frequency diverse array transmitting end of the jammer.

Step 6: The frequency diverse array jammer uses the array form of the frequency diverse array to detect the enemy reconnaissance area where the moving target is in the T area, and transmit jamming signal J(t).

Step 7: A large number of moving targets in the area will reflect the jamming signal generated in step 6 to the enemy's reconnaissance radar.

Step 8: The enemy's radar will detect a mixture of echo signals and a large number of jamming signals, and its received signal 2796. Among, 2826; Is the time delay of the real target echo, 2863; Is the time delay of the interference signal.

Step 9: The jamming false target effect generated by the frequency diverse array jammer on the enemy radar is estimated, and the number of false targets generated with the number of false targets generated by the common single antenna repeater jamming is compared.

The invention discloses a radar jamming method based on a frequency diverse array jammer. Compared with the prior art, the method has the advantages as follows.

(1) The jamming signal in most of the existing arts is transmitted through the traditional array antenna, while the disclosure transmits the jamming signal through a new type of frequency controlled array antenna, which is an innovation in principle.

(2) Compared with the traditional jamming, the reflection of the jamming signal by the target is more concealed than the direct exposure of the jammer in the enemy's monitoring area, and the “S” type jamming signal emitted by the frequency diverse array provides another layer of concealment for the jammer.

(3) The deception effect of the existing jamming method on the enemy radar is limited, and it is easy to identify the jamming law and lose the jamming effect. The flexible configuration of the intermediate frequency array jammer in this method will make it difficult for the enemy radar to identify the law, thus making the deception jamming effect better.

(4) the invention not only aims at a certain new system radar of the enemy, but also is suitable for various new system radars, has better jamming effect and wide application range.

### BRIEF DESCRIPTION OF THE DRAWINGS

FIG. 1 is a general flow chart of the disclosure.

FIG. 2 is a modeling diagram of an application scenario of the disclosure.

FIG. 3 is a schematic diagram of an array structure of a uniform linear frequency diverse array used in the disclosure.

FIG. 4A is a time-frequency simulation diagram of conventional interference.

FIG. 4B is a simulation diagram of frequency diverse array jamming according to the disclosure.

### DETAILED DESCRIPTION OF THE EMBODIMENTS

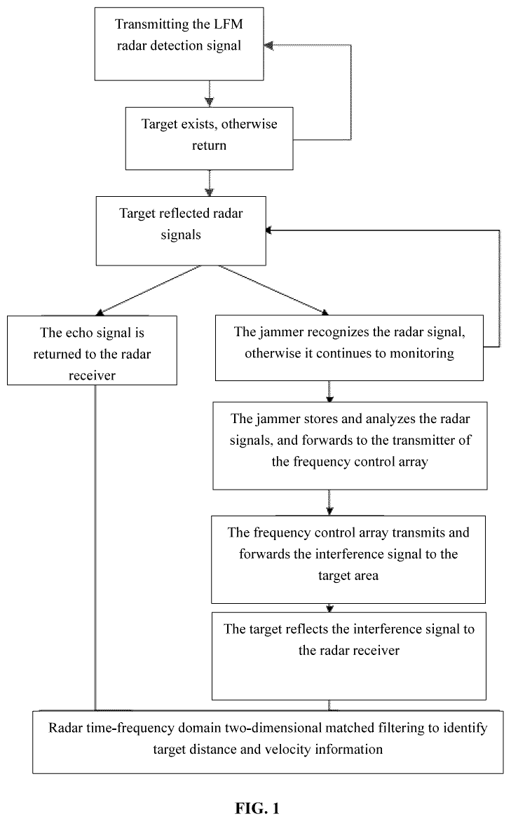

A general flow diagram of an embodiment of the disclosure is shown in FIG. 1.

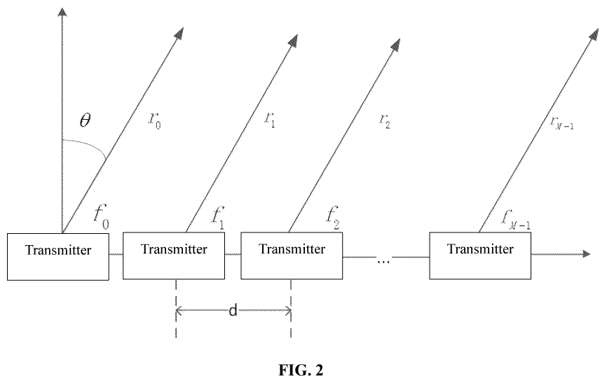

Aiming at overcoming the defects of the prior art, the radar jamming method based on a frequency diverse array jammer is designed, and an application scene as shown in FIG. 2 is established. The area T is the monitoring and protection area of enemy reconnaissance radar. In order to avoid being detected by enemy radar, our jammer is designed to be flexibly placed outside the area T. Assuming that the point Jᵢ is the location of the frequency diverse array jammer and the number of i can be flexibly configured. The enemy radar, modeled as a monostatic pulse Doppler radar, is shown in point E. The purpose of our frequency diverse array jammer is to hide our moving targets entering the enemy radar reconnaissance area, and to make the enemy radar unable to monitor our moving targets normally by forming the illusion of multiple false targets, so that the enemy radar cannot judge the location and speed of our real targets. The frequency diverse array jammers can work individually in turn, or work in coordination with multiple ones, which makes it difficult for the enemy reconnaissance radar to identify our jamming rules, and when there are multiple moving targets, the generation of a large number of false targets will seriously affect the normal work of the enemy radar and make it lose its detection function.

The technical scheme of the invention is based on the established application scene model, and the specific technical scheme of the interference method is as following.

In this embodiment, the enemy radar is modeled as a pulse Doppler radar, which is designed based on the principle that the target and the jammer have different radial velocities relative to the radar, and the echo signals also have different Doppler frequencies. Its main feature is that it has strong anti-deception interference and anti-noise ability. Generally, the jamming to pulse Doppler radar can be divided into blanket jamming, distance deception jamming and velocity deception jamming. The frequency diverse array jamming opportunity designed by the invention tries to realize the effects of the three jamming forms at the same time, so that the frequency diverse array jamming opportunity is more effective in jamming a pulse Doppler radar.

The radar signal adopted by the method is a linear frequency modulation signal, and the time domain expression of the linear frequency modulation signal is as follows: s(t)=exp{j(2πf₀t+πkᵣt²)}; Wherein, f₀ is the carrier frequency, kᵣ is the frequency modulation. The pulse duration T is set as 10 us. The bandwidth B is 30 MHZ. The frequency modulation is

$${k}_{r} = \frac{B}{T} .$$

The number of the array elements of the frequency diverse array structure adopted by the disclosure is 10. The distance d between the array elements is half of the wavelength λ. The frequency difference Δf between the array elements is 10 kHz. The transmitting beam of the frequency diverse array points to the target area T.

The specific implementation steps are as follows:

Step 1: Monostatic pulse Doppler radar at the point E in the area T transmits the LFM pulse signal, and the signal expression is s(t)=exp{j(2πf₀t+πkᵣt²)}. Wherein f₀ is the carrier frequency of the radar. The parameters are initialized and f₀=10 GHZ,

$${k}_{r} = \frac{B}{T}$$

is the frequency modulation. The bandwidth B is 30 MHZ. The pulse duration T is set as 10 us. The time domain is

$$- \frac{T}{2} \leq t \leq \frac{T}{2} .$$

The presence of a target in the area is detected.

Step 2: When there is a moving target in the area T, the radar signal will be reflected. A part of the signal will be reflected to the radar receiver, which is recorded as the echo signals sᵣ(t)=s(t−τ₁). The time delay of the echo signal is τ₁.

$${τ}_{1} = \frac{r}{c} .$$

r is the distance to the target. Moving targets will have Doppler frequency shift f_{d}, and

$${f}_{d} = \frac{2 v}{λ} .$$

At this point, the radial velocity of the moving target v can be calculated by measuring f_{d}.

Step 3: Part of the signal will be reflected by the target to our frequency diverse array jammer. This simulation assumes that only one frequency diverse array jammer is in operation. The jammer receives the signal with DRFM and accurately stores and analyzes the signal parameters.

Step 4: The DRFM forwards the signal to the transmitting end of the frequency diverse array jammer. The number of array elements is 10, and the array element spacing is d is half of the wavelength, and the frequency difference Δf between array elements is 10 kHz. The jamming beam is aimed at the target area by setting appropriate weights.

Step 5, the simulated frequency diverse array jamming signal is directly based on the radar signal s(t) received by the jammer and forwards frequency control array for jamming signal J(t)=s(t−τ₂)⊗h(t). The h(t) is equivalent to the array response of a frequency controlled array.

Step 6: The characteristic of frequency diverse array transmission is that jamming signals of different frequencies can be sent to the target area at the same time. The simulation is based on the situation of a single moving target. When there are multiple moving targets, the effect is better.

Step 7: the jamming signal of each array element is reflected to the radar receiver by the target, and the jamming signal superposition expression is

$${J}_{total} ( t ) = {\sum }_{m = 1}^{10} J ( t ) {e}^{j 2 π ( {f}_{0} + ( m - 1 ) Δ f ) t} .$$

Step 8: The radar receiver receives the sum signal of the target echo signal and the control array jamming signal r(t)=sᵣ(t)+Jₜₒₜₐₗ(t).

Step 9: The radar receiver performs two-dimensional matched filtering in the time-frequency domain. When the signal strength is greater than a certain threshold, it can be determined that there is a target. At this time, the deceptive jamming signal will be regarded as the real target echo signal by the radar receiver, thus affecting the judgment of the distance and speed of the moving target.

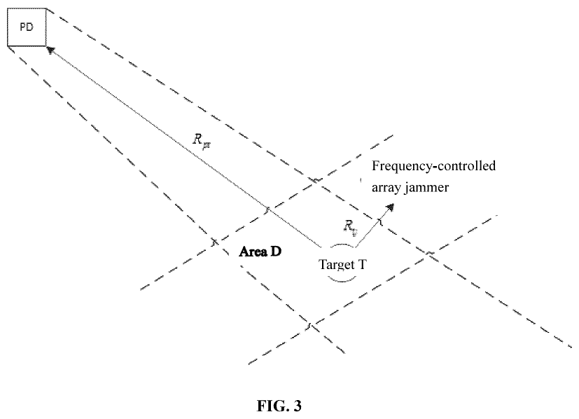

The innovative point of the invention lies in the application of the novel array of the frequency diverse array, and the frequency diverse array is applied to the jammer to obtain a more effective jamming effect than the traditional jammer. The concept of frequency array is derived from phased array. One of the advantages of phased array radar is that it can freely realize the spatial scanning of the beam. Usually, each array element transmits and receives the same signal, and the spatial scanning of the beam is realized by adjusting the phase shift of the phase shifter. Therefore, phased array has been widely used in modern communication, radar and navigation systems. The difference between frequency array and phased array is that there is a small frequency increment between the carrier frequencies of adjacent array elements. The concept of frequency array is proposed to improve the range dependence that phased array does not have, which makes it possible to suppress range-dependent interference and clutter. Frequency-controlled array beam is a periodic function of time, angle and distance, and a uniform linear frequency-controlled array structure is generally used. The M transmit antennas spaced d are uniformly arranged, as shown in FIG. 3. The carrier frequency of the transmitting signal of the first array element is recorded as f₀, the carrier frequency difference of signals transmitted by adjacent array elements is Δf. The carrier frequencies of the signals transmitted by the M array elements are:

fₘ=f₀+(m−1)·Δf, m=1,2, . . . ,M (1)

According to the method, the frequency diverse array is used for transmitting the interference signals, so that the interference signals transmitted by each array element are different in frequency: on one hand, the power of the interference signals is enhanced in an array form, and on the other hand, the transmitted interference signals show difference in frequency, so that serious trouble is caused to detection of a target of a hostile radar on a frequency domain. The transmitted original interference signal is assumed to be J(t), then the signal transmitted by each array element of the frequency diverse array is:

Jₘ(t)=J(t)·e^{j2πf}^{ₘ}^{t} (2)

When a mth jamming signal transmitted to the far field of (rₘ,θ), its signal expression is

$$\hat{{J}_{m}} ( t ) = {J}_{m} ( t - \frac{{r}_{m}}{c} ) \qquad ( 3 )$$

Among which,

rₘ=r−(m−1)d sin θ (4)

θ is the target direction and r is the distance from the first array element to the target of the reference array element.

Bring (1), (2) and (4) into (3) to obtain the signal:

$$\begin{matrix}\hat{{J}_{m}} ( t ) = J ( t - \frac{{r}_{m}}{c} ) \cdot {e}^{j 2 π ( {f}_{0} + ( m - 1 ) \cdot Δ f ) \cdot ( t \frac{r - ( m - 1 ) d sin θ}{c} )} \\ \approx J ( t - \frac{r}{c} ) \cdot {e}^{j 2 π ( {f}_{0} t + ( m - 1 ) \cdot Δ f t - \frac{{f}_{0} r}{c} + \frac{( m - 1 ) {f}_{0} d sin θ}{c} - \frac{( m - 1 ) Δ fr}{c} + \frac{{( m - 1 )}^{2} Δ fd sin θ}{c} )}\end{matrix} \qquad ( 5 )$$

By simplifying and ignoring the minimum terms, the result of the interference signal superposition at the far-field target is

$$\begin{matrix}{J}_{total} ( t ) = {\sum }_{m = 1}^{M} \hat{{J}_{m}} ( t ) \\ = J ( t - \frac{r}{c} ) \cdot {e}^{j 2 π {f}_{0} t} \cdot {\sum }_{m = 1}^{M} exp ( j 2 π ( ( m - 1 ) \cdot Δ f t + \\ \frac{( m - 1 ) {f}_{0} d sin θ}{c} - \frac{( m - 1 ) Δ fr}{c} + \frac{{( m - 1 )}^{2} Δ fd sin θ}{c} ) )\end{matrix} \qquad ( 6 )$$

The first term of the exponential term reflects the time variation of FDA, the second term is the same as the phase difference of phased array, the third term reflects the distance and frequency increment dependence of FDA, and the fourth term reflects that FDA has a coupling relationship in distance and angle. It can be seen that the FDA beam pattern is not only angle dependent, but also time and distance dependent. Moreover, the generated “S” beam also provides a good guarantee for the stealth performance of the jammer itself, which can affect the enemy radar's monitoring and identification of our jammer.

Pulse Doppler radar is a new type of radar which uses the Doppler effect produced by the relative motion between the target and the radar to achieve the function of speed measurement. Pulse Doppler radar is proposed to solve the problem of strong ground clutter interference of airborne downward-looking radar. It is a kind of full coherent radar which uses Doppler effect to detect target information, can realize the single spectral line filtering of radar signal pulse string spectrum, has the ability to distinguish the target speed, and can more effectively solve the problem of suppressing strong ground clutter interference. In addition, the pulse Doppler radar can be sensitive to measure the range and velocity information at the same time, and can use Doppler processing technology to achieve high-resolution synthetic aperture images. Since most of the existing airborne radars adopt the pulse Doppler system, the radar in the present invention is also modeled as a pulse Doppler radar.

The radar signal adopted by the invention is a Linear Frequency Modulation (LFM) signal, the characteristic of large time width of the LFM signal improves the speed resolution and the velocity measurement precision of a radar system, and the characteristic of large bandwidth of the LFM signal improves the distance resolution and the ranging precision of the radar system. At the same time, in order to improve the detection range of the radar system, the signal must have large energy, and the pulse compression technology effectively solves the contradiction between the detection range and the range resolution of the radar system. As a pulse compression technology, linear frequency modulation (LFM) has become one of the most commonly used radar signals in modern radar. The time-domain expression for a chirp signal is s(t)=exp{j(2πf₀t+πkᵣt²)}, wherein f₀ is the carrier frequency, kᵣ is the frequency modulation. Let the pulse duration be T, the FM bandwidth is B, then adjust the frequency

$${k}_{r} = \frac{B}{T} .$$

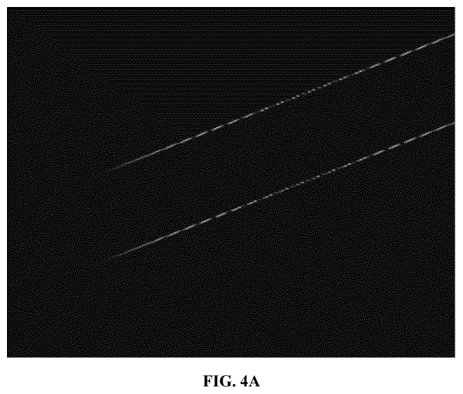

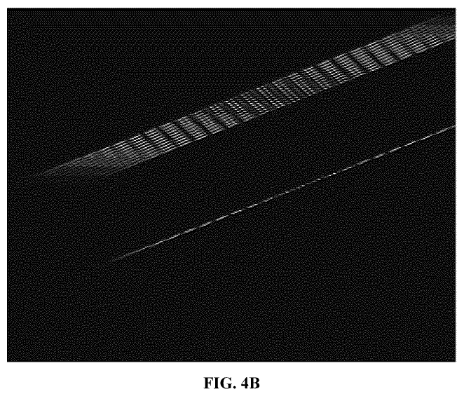

The LFM signal is the signal received after compression processing, whose output pulse peak power is D times of the input pulse peak power. When the output power of the transmitter is fixed, the target echo signal output by the receiver has a narrower pulse width and higher peak power after being compressed by the matched filter, which improves the range resolution and detection range of the radar system at the same time. This unique advantage makes its application prospect very considerable. As shown in FIG. 4A and FIG. 4B.

What is claimed is:

1. A method of radar jamming based on a frequency diverse array jammer, comprising:
step 1: simulating an enemy pulse Doppler reconnaissance radar with a position E, the radar covers a detection area of T to which the radar transmits a radar signal s(t); judging whether an external target enters the area by detecting an echo signal;
step 2: reflecting the signal s(t) sent by the enemy radar to the area when a moving target enters the T; part of the reflected signal is returned to the radar receiver as a true echo signal, and the other part of the signal is reflected to the frequency diverse array jammer placed outside the area;
step 3: repeatedly identifying and searching the signals sent or reflected by the area by the jammer; when the signal strength received by the jammer is greater than a certain threshold, it is determined that the jammer has searched the enemy reconnaissance signal reflected by the target, otherwise, the jammer continues to search;
step 4: the jammer uses the DRFM to identify and store the received enemy reconnaissance signal, so as to realize the high-speed capture and storage of the signal;
step 5: accurately judging the parameters of the radar signal received in the step 4, accurately copying the signal, and forwarding the signal to a frequency diverse array transmitting end of a jammer;
step 6: emitting interference signal J(t) to the area of the enemy detection area T where the moving object is located;
step 7: reflecting, by a plurality of the moving targets in the area, the jamming signal generated in the step 6 to the reconnaissance radar of the enemy;
step 8: detecting, by the radar of the enemy, a mixed signal of an echo signal and a large number of interference signals; and
step 9: estimating the jamming false target effect of the frequency diverse array jammer on the enemy radar.

2. The method of claim 1, wherein in the step 5, parameters of the radar signal include pulse pattern and pulse period.

3. The method of claim 1, wherein in step 6, the frequency diverse array jammer is used to transmit the jamming signal in an array form of the frequency diverse array.

4. The method of claim 1, wherein in step 8, the enemy radar receiving signal is r(t)=s(t−τ₁)+J(t−τ₂); wherein the time delay of the real target echo is τ₁; and the time delay of the interference signal is τ₂.

5. The method of claim 1, wherein the effect of jamming false targets in step 9 is compared with that of ordinary single antenna repeater jamming, and the number of generated false targets is compared.
